(19) United States
(12) Patent Application Publication
(10) Pub. No.: US 2012/0256876 A1
(43) Pub. Date: Oct. 11, 2012

(54) CAPACITIVE TOUCHPAD

(75) Inventors: I-HAU YEH, TAIPEI CITY (TW); TA-FAN HSU, NEW TAIPEI CITY (TW); SHU-WEI HUANG, TAIPEI CITY (TW)

(73) Assignee: ELAN MICROELECTRONICS CORPORATION, HSINCHU (TW)

(21) Appl. No.: 13/441,075

(22) Filed: Apr. 6, 2012

(30) Foreign Application Priority Data
Apr. 11, 2011 (TW) 100112513

(51) Int. Cl. G06F 3/045

(52) U.S. Cl. 345/174

(57) ABSTRACT

A capacitive touchpad has insulating blocks provided above and below a resilient layer. The insulating blocks above the resilient layer are offset in position with respect to the insulating blocks below the resilient layer. Due to the insulating blocks, a plurality of gaps are formed in the capacitive touchpad. The gaps are filled with a fluid medium. When a conductive or non-conductive object touches the capacitive touchpad, the resilient layer is deformed at the touched position and thereby displaces the fluid medium completely from the affected gaps. As a result, the distance and the dielectric coefficient between the resilient layer or an electrode plate and a sensor layer are changed, causing variation in capacitance.

### FIELD OF THE INVENTION

The present invention relates to a capacitive touchpad and, more particularly, to a capacitive touchpad to be operated by non-conductors as well as conductors.

### BACKGROUND OF THE INVENTION

Conventionally, a capacitive touchpad uses a plurality of sensors to detect the touch of an object. The equation for capacitance is as follows:

$$C = \frac{ɛ A}{d} , \qquad [ Eq \text{-} 1 ]$$

where A is the overlapping area between two electrodes, d is the distance between the two electrodes, and E is the dielectric constant of the dielectric layer between the two electrodes. When a conductor (e.g., a finger) touches a capacitive touchpad, the capacitance of the sensor at the touched position is changed. A detector detects the change in capacitance and thereby determines the location of the touched position. The conventional technique described above is disadvantageous in that it is applicable only to the detection of capacitance variation caused by a human finger or by a conductor having a certain area; in other words, the conventional technique cannot be used to detect capacitance variation caused by a non-conductor.

### SUMMARY OF THE INVENTION

An objective of the present invention is to provide

According to the present invention, a capacitive touchpad includes a protective layer, a resilient conductive layer below the protective layer, a sensor layer below the resilient conductive layer, a plurality of first insulating blocks between the protective layer and the resilient conductive layer, and a plurality of second insulating blocks between the resilient conductive layer and the sensor layer. The sensor layer has an insulating layer on the upper surface. The second insulating blocks are offset in position with respect to the first insulating blocks. The sensor layer and the resilient conductive layer form a capacitor.

According to the present invention, a capacitive touchpad includes a protective layer, a resilient insulating layer below the protective layer, a sensor layer below the resilient insulating layer, a plurality of first insulating blocks between the protective layer and the resilient insulating layer, and a plurality of second insulating blocks between the resilient insulating layer and the sensor layer. The protective layer has a conductive electrode plate on the lower surface. The second insulating blocks are offset in position with respect to the first insulating blocks. The sensor layer and the conductive electrode plate form a capacitor.

According to the present invention, a capacitive touchpad includes a flexible sensor layer, a resilient conductive layer below the flexible sensor layer, a bottom plate below the resilient conductive layer, a plurality of first insulating blocks between the flexible sensor layer and the resilient conductive layer, and a plurality of second insulating blocks between the resilient conducive layer and the bottom plate. The flexible sensor layer has a protective film on the upper surface and an insulating film on the lower surface. The second insulating blocks are offset in position with respect to the first insulating blocks. The flexible sensor layer and the resilient conductive layer form a capacitor.

According to the present invention, a capacitive touchpad includes a flexible sensor layer, a resilient insulating layer below the flexible sensor layer, a conductive layer below the resilient insulating layer, a plurality of first insulating blocks between the flexible sensor layer and the resilient insulating layer, and a plurality of second insulating blocks between the resilient insulating layer and the conductive layer. The flexible sensor layer has a protective film on the upper surface. The second insulating blocks are offset in position with respect to the first insulating blocks. The flexible sensor layer and the conductive layer form a capacitor.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a sectional view of the capacitive touchpad in the first embodiment of the present invention;

FIGS. 2a and 2b schematically show operation of the embodiment depicted in FIG. 1;

FIG. 3 is a waveform diagram of driving signals applied to the capacitive touchpad of the present invention;

FIG. 4 is a sectional view of the capacitive touchpad in the second embodiment of the present invention;

FIGS. 5a and 5b schematically show operation of the embodiment depicted in FIG. 4;

FIG. 6 is a sectional view of the capacitive touchpad in the third embodiment of the present invention;

FIGS. 7a and 7b schematically show operation of the embodiment depicted in FIG. 6;

FIG. 8 is a sectional view of the capacitive touchpad in the fourth embodiment of the present invention;

FIGS. 9a and 9b schematically show operation of the embodiment depicted in FIG. 8;

FIG. 10 is a schematic perspective view of the insulating blocks provided on the upper and lower surfaces of the resilient layer in each of the foregoing embodiments; and

FIGS. 11-13 are top views of different insulating block arrangements.

### DETAILED DESCRIPTION OF THE INVENTION

The present invention provides a capacitive touchpad. When an object—be it a conductor or non-conductor—touches the capacitive touchpad of the present invention, the coordinates corresponding to the touched position can be determined according to capacitance variation caused by changes in the distance and the dielectric coefficient between two electrodes.

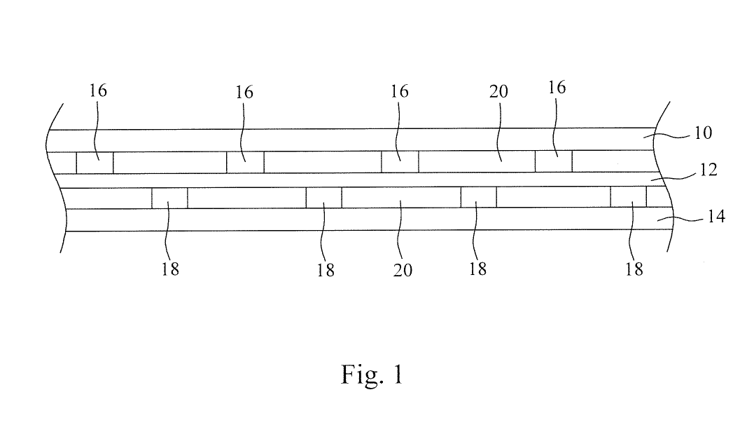

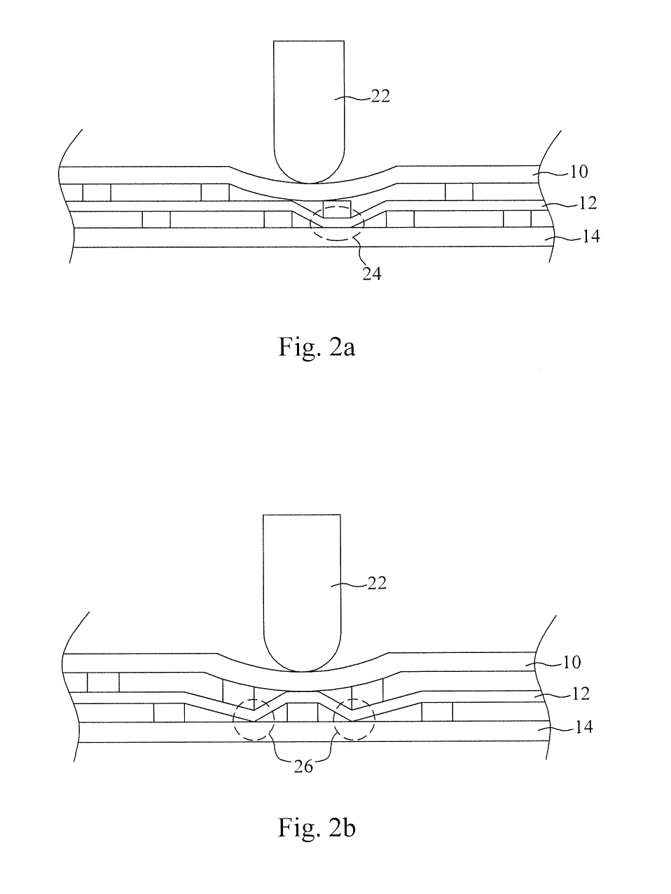

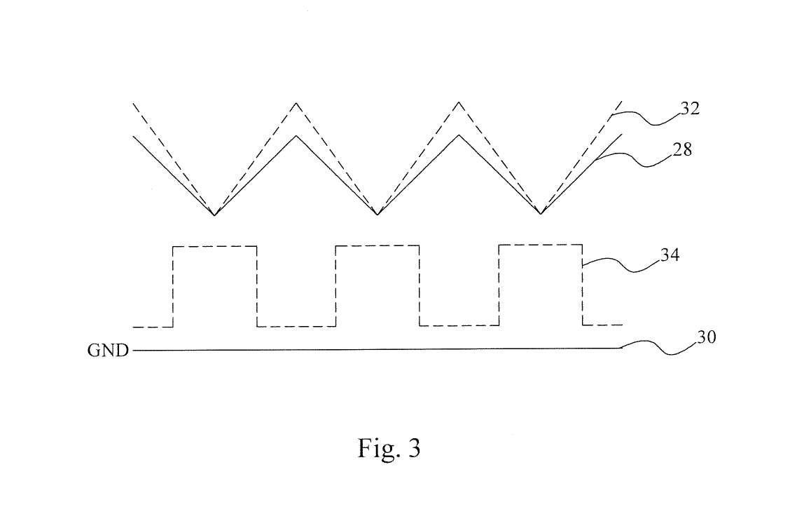

FIG. 1 is a sectional view of the capacitive touchpad in the first embodiment of the present invention, and FIGS. 2a and 2b are schematic views of the capacitive touchpad during operation. The capacitive touchpad in this embodiment has a protective layer 10, a resilient conductive layer 12, and a sensor layer 14. The resilient conductive layer 12 is provided between the protective layer 10 and the sensor layer 14. The sensor layer 14 has an insulating layer on the upper surface. In one embodiment, the sensor layer 14 is made of a printed circuit board. Additionally, the capacitive touchpad of the present invention has a plurality of first insulating blocks 16 provided between the resilient conductive layer 12 and the protective layer 10, and a plurality of second insulating blocks 18 provided between the resilient conductive layer 12 and the sensor layer 14. The first insulating blocks 16 are offset in position with respect to the second insulating blocks 18. Due to the insulating blocks 16 and 18, a plurality of gaps 20 are formed between the resilient conductive layer 12 and the protective layer 10 and between the resilient conductive layer 12 and the sensor layer 14. The gaps 20 are filled with a fluid medium. In one embodiment, the gaps 20 are filled with air to save material costs. The resilient conductive layer 12 and the sensor layer 14 form a capacitor. Referring to FIGS. 2a and 2b, when the capacitive touchpad is touched by an object 22, the touching force acts downward on the protective layer 10 and causes deformation of the resilient conductive layer 12; as a result, the fluid medium in the gaps 20 are compressed. In particular, the fluid medium at the deformed position 24, 26 is completely displaced such that the average dielectric coefficient of the medium between the resilient conductive layer 12 and the sensor layer 14 is changed. Thus, deformation of the resilient conductive layer 12 causes both the distance and the dielectric coefficient between the resilient conductive layer 12 and the sensor layer 14 to vary at the deformed position 24, 26, which in turn causes variation in capacitance. A detector (not shown, i.e., a control IC) can then determine the location of the deformed position 24 or 26 according to the capacitance variation. In order to detect capacitance, the detector applies a first driving signal to the sensor layer 14, as shown by the waveform 28 in FIG. 3. Meanwhile, the resilient conductive layer 12 is at ground potential, as shown by the waveform 30 in FIG. 3. In another embodiment, a second driving signal in anti-phase with the first driving signal is applied to the resilient conductive layer 12, as shown by the waveform 34 in FIG. 3, so as to amplify the detected capacitance signal. In yet another embodiment, the amplitude of the first driving signal applied to the sensor layer 14 is increased, as shown by the waveform 32 in FIG. 3. This serves to amplify the detected capacitance signal just as well.

As would be understood by a person skilled in capacitive touch control technology, the sensor layer includes a plurality of sensors, and the sensor layer of the touchpad can be made of a printed circuit board or by a film making process. Moreover, the sensors can be made of metal or indium tin oxide (ITO). The structures, shapes, and compositions of the sensor layer and the sensors are well known to a person skilled in touch control technology. All such known structures, shapes, and compositions are applicable to the present invention.

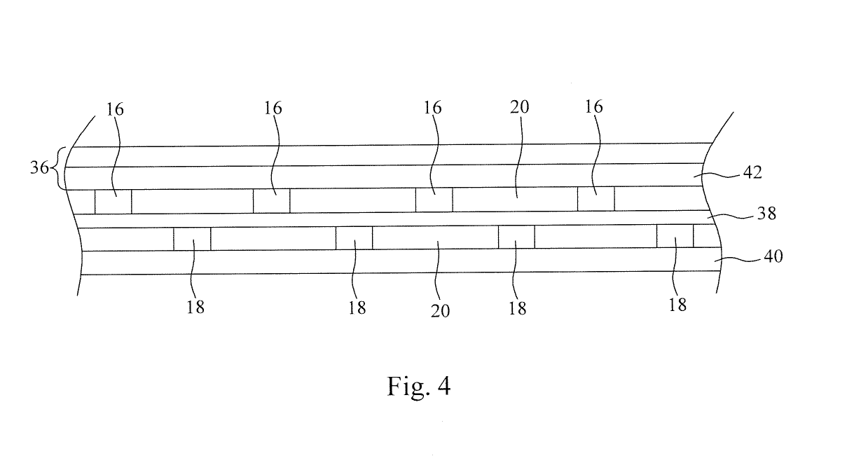

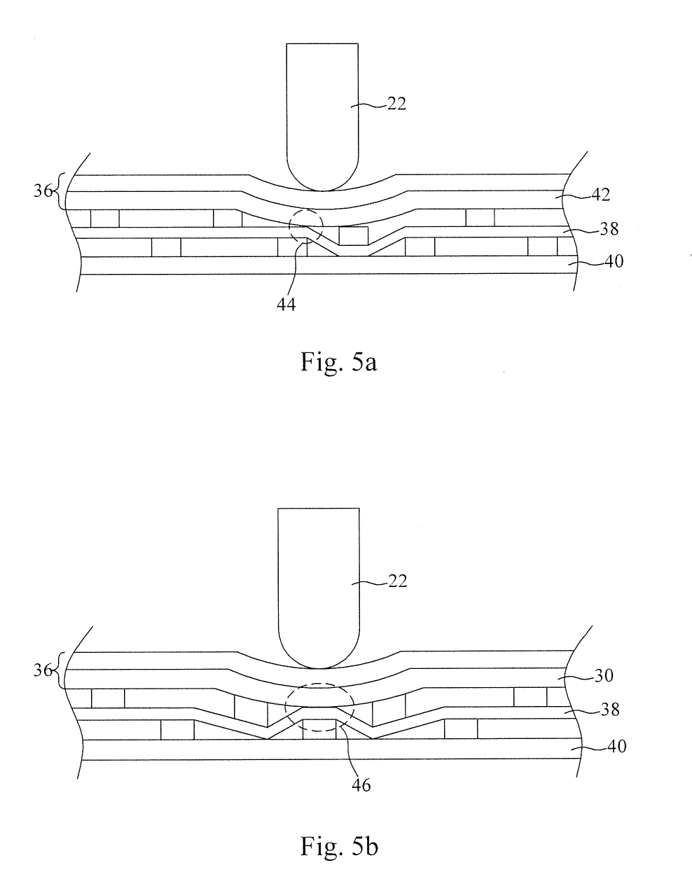

FIG. 4 is a sectional view of the capacitive touchpad in the second embodiment of the present invention, and FIGS. 5a and 5b are schematic views of the capacitive touchpad in operation. The capacitive touchpad in this embodiment has a protective layer 36, a resilient insulating layer 38, and a sensor layer 40. The resilient insulating layer 38 is provided between the protective layer 36 and the sensor layer 40. The lower surface of the protective layer 36 is formed as a conductive electrode plate 42. In addition, the capacitive touchpad of the present invention has a plurality of first insulating blocks 16 provided between the resilient insulating layer 38 and the protective layer 36, and a plurality of second insulating blocks 18 provided between the resilient insulating layer 38 and the sensor layer 40. The first insulating blocks 16 are offset in position with respect to the second insulating blocks 18. Due to the insulating blocks 16 and 18, a plurality of gaps 20 are formed between the resilient insulating layer 38 and the protective layer 36 and between the resilient insulating layer 38 and the sensor layer 40. The gaps 20 are filled with a fluid medium. The conductive electrode plate 42 and the sensor layer 40 form a capacitor. When the capacitive touchpad is touched by an object 22, referring to FIGS. 5a and 5b, the touching force acts downward on the protective layer 36 and deforms the resilient insulating layer 38, thereby compressing the fluid medium in the gaps 20. The fluid medium at the deformed position 44, 46 is completely displaced such that the average dielectric coefficient of the medium between the conductive electrode plate 42 and the sensor layer 40 is changed. Thus, deformation of the resilient insulating layer 38 causes the distance and the dielectric coefficient between the conductive electrode plate 42 and the sensor layer 40 to vary at the deformed position 44, 46, and this causes variation in capacitance. A detector (not shown) then determines the location of the deformed position 44 or 46 according to the capacitance variation. In order to detect capacitance, the detector applies to the sensor layer 40 a first driving signal as shown by the waveform 28 or 32 in FIG. 3. At the meantime, the conductive electrode plate 42 is at ground potential, or the detector applies to the conductive electrode plate 42 a signal in anti-phase with the first driving signal, as shown by the waveform 34 in FIG. 3.

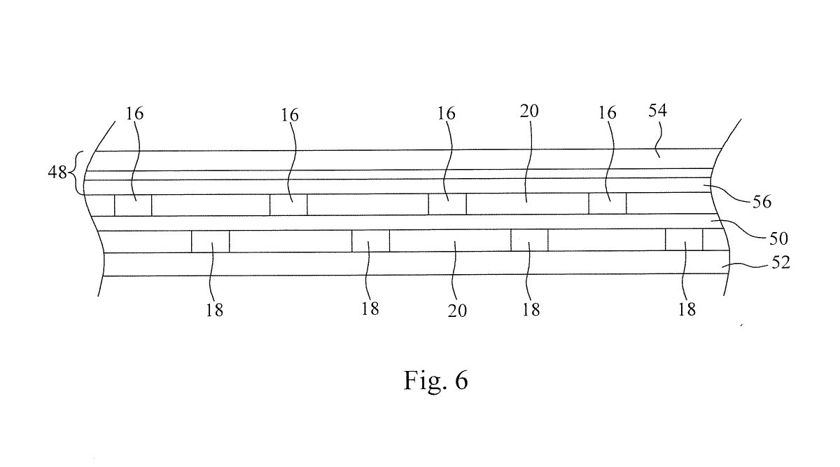

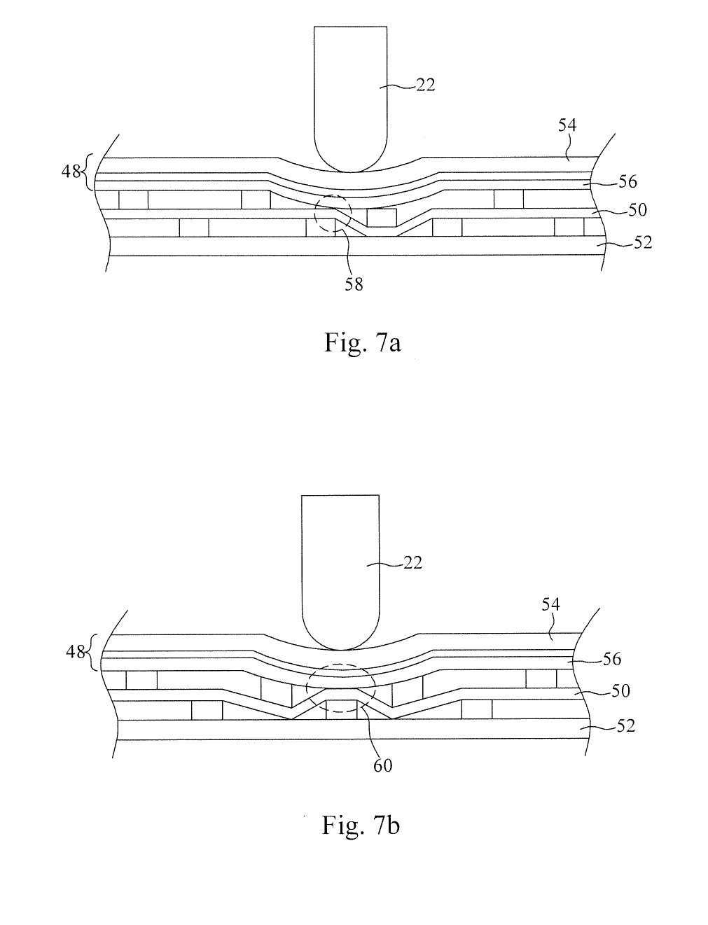

FIG. 6 is a sectional view of the capacitive touchpad in the third embodiment of the present invention, and FIGS. 7a and 7b are schematic views of the capacitive touchpad during operation. In this embodiment, the capacitive touchpad has a flexible sensor layer 48, a resilient conductive layer 50, and a supporting bottom plate 52. The resilient conductive layer 50 is provided between the flexible sensor layer 48 and the supporting bottom plate 52. The flexible sensor layer 48 has a protective film 54 on the upper surface and an insulating film 56 on the lower surface. In addition, the capacitive touchpad of the present invention has a plurality of first insulating blocks 16 provided between the resilient conductive layer 50 and the flexible sensor layer 48, and a plurality of second insulating blocks 18 provided between the resilient conducive layer 50 and the supporting bottom plate 52. The first insulating blocks 16 are offset in position with respect to the second insulating blocks 18. Because of the insulating blocks 16 and 18, a plurality of gaps 20 are formed between the resilient conductive layer 50 and the flexible sensor layer 48 and between the resilient conductive layer 50 and the supporting bottom plate 52. The gaps 20 are filled with a fluid medium. The resilient conductive layer 50 and the flexible sensor layer 48 form a capacitor. Referring to FIGS. 7a and 7b, an object 22 touching the capacitive touchpad applies a downward touching force to the flexible sensor layer 48 and causes deformation of the resilient conductive layer 50; consequently, the fluid medium in the gaps 20 is compressed. As the fluid medium at the deformed position 58, 60 is completely displaced, the average dielectric coefficient of the medium between the resilient conductive layer 50 and the flexible sensor layer 48 is changed. Thus, deformation of the resilient conductive layer 50 causes the distance and the dielectric coefficient between the resilient conductive layer 50 and the flexible sensor layer 48 to vary at the deformed position 58, 60, and capacitance variation takes place accordingly. A detector (not shown) then determines the location of the deformed position 58 or 60 based on the capacitance variation. In order to detect capacitance, a first driving signal as shown by the waveform 28 or 32 in FIG. 3 is applied to the flexible sensor layer 48 while the resilient conductive layer 50 is at ground potential or is supplied with a second driving signal in anti-phase with the first driving signal, as shown by the waveform 34 in FIG. 3.

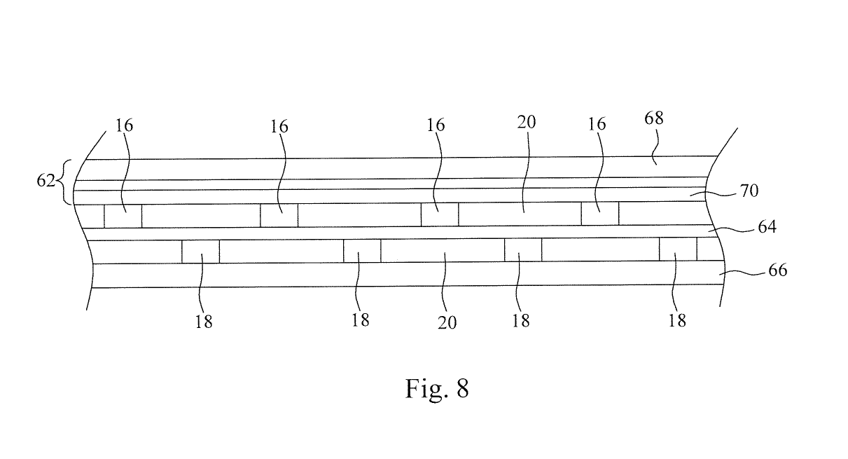

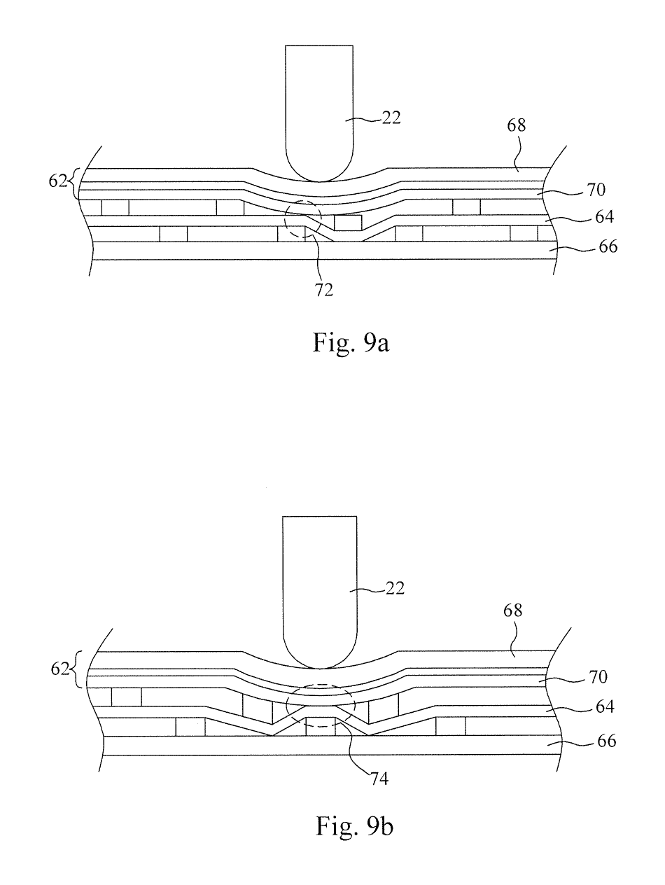

FIG. 8 is a sectional view of the capacitive touchpad in the fourth embodiment of the present invention, and FIGS. 9a and 9b schematically show the capacitive touchpad in operation. In this embodiment, the capacitive touchpad has a flexible sensor layer 62, a resilient insulating layer 64, and a conductive layer 66. The resilient insulating layer 64 is provided between the flexible sensor layer 62 and the conductive layer 66. The flexible sensor layer 62 has a protective film 68 on the upper surface and an insulating film 70 on the lower surface. Additionally, the capacitive touchpad of the present invention has a plurality of first insulating blocks 16 provided between the resilient insulating layer 64 and the flexible sensor layer 62, and a plurality of second insulating blocks 18 provided between the resilient insulating layer 64 and the conductive layer 66. The first insulating blocks 16 are offset in position with respect to the second insulating blocks 18. Due to the insulating blocks 16 and 18, a plurality of gaps 20 are formed between the resilient insulating layer 64 and the flexible sensor layer 62 and between the resilient insulating layer 64 and the conductive layer 66. The gaps 20 are filled with a fluid medium. The flexible sensor layer 62 and the conductive layer 66 form a capacitor. Referring to FIGS. 9a and 9b, when an object 22 touches the capacitive touchpad, the touching force acts downward on the flexible sensor layer 62 and thereby deforms the resilient insulating layer 64, causing compression of the fluid medium in the gaps 20. The fluid medium is completely displaced at the deformed position 72, 74 such that the average dielectric coefficient of the medium between the flexible sensor layer 62 and the conductive layer 66 is changed. Thus, deformation of the resilient insulating layer 64 causes the distance and the dielectric coefficient between the conductive layer 66 and the flexible sensor layer 62 to vary at the deformed position 72, 74, and capacitance variation follows. A detector (not shown) then determines the location of the deformed position 72 or 74 according to the capacitance variation. In order to detect capacitance, a first driving signal as shown by the waveform 28 or 32 in FIG. 3 is applied to the flexible sensor layer 62 while the conductive layer 66 is at ground potential or is supplied with a second driving signal in anti-phase with the first driving signal, as shown by the waveform 34 in FIG. 3.

In the foregoing embodiments, capacitance variation is caused by changing the distance and the dielectric coefficient between two electrodes and can be expressed as:

$$Δ C = ɛ \frac{A}{Δ d} = k \cdot {ɛ}_{0} \frac{A}{Δ d} . \qquad [ Eq \text{-} 2 ]$$

For example, assume that the touchpad of the present invention is touched by the tip of a pen, wherein the radius of the tip is 1.5 mm. Further assume that the fluid medium is air and the thickness d of each insulating block is 0.1 mm. Substitution of the related parameters into the equation Eq-2 yields a capacitance variation

$$Δ C = 1.004 \times 8.8854 \times {10}^{- 12} \frac{π \times {0.0015}^{2}}{0.0001} = 0.628 pF .$$

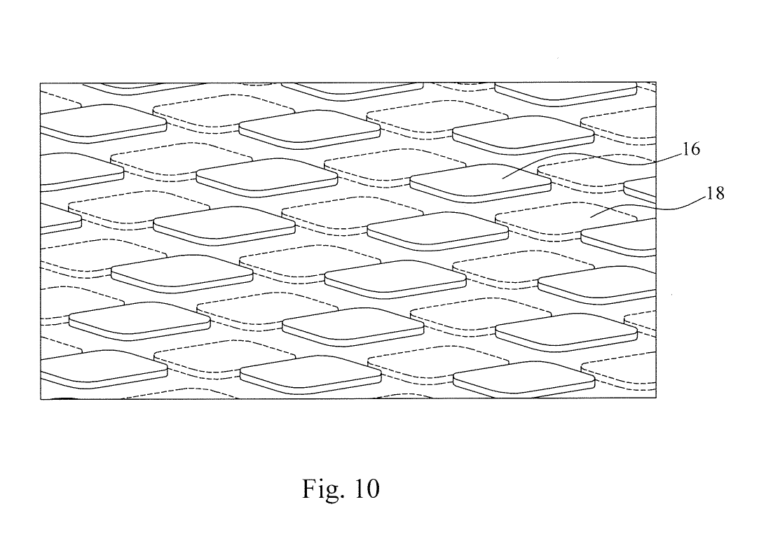

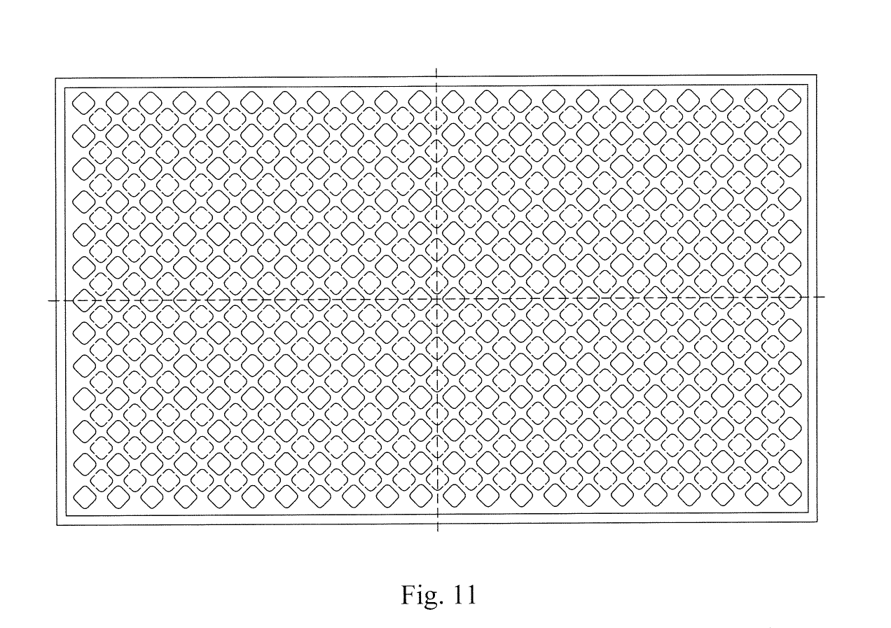

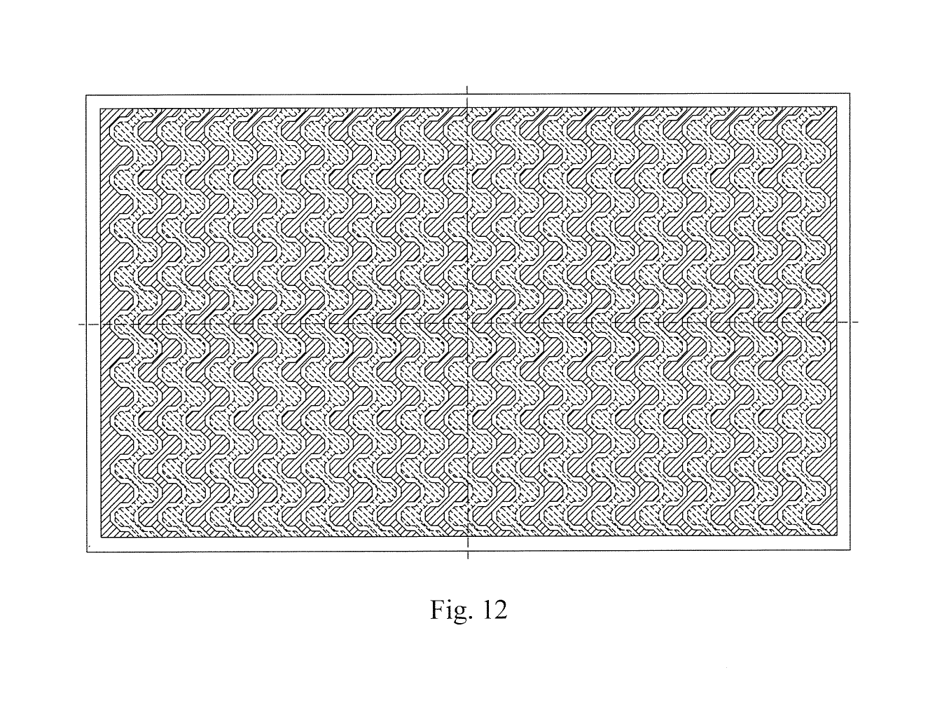

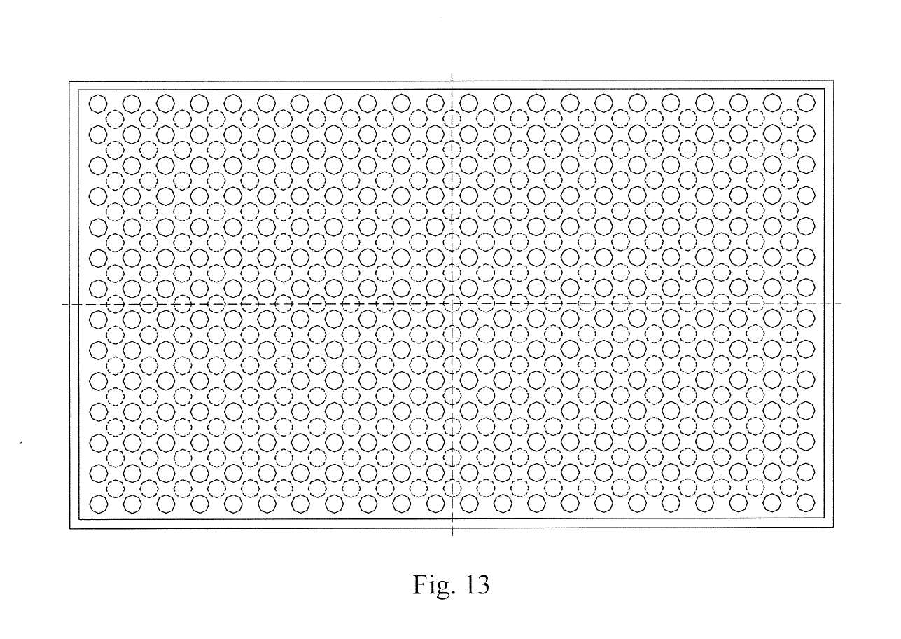

FIG. 10 is a schematic perspective view of the insulating blocks 16 and 18 provided on the upper and lower surfaces of the resilient layer in each of the foregoing embodiments. The present invention imposes no limitations on the structures and shapes of the insulating blocks 16 and 18, provided that the insulating blocks on the upper surface are offset in position with respect to the insulating blocks on the lower surface. FIGS. 11-13 are top views showing different arrangements of the insulating blocks 16 and 18. In the embodiments shown in FIGS. 1 and 6, the resilient conductive layers can be made of a conductive poly styrene film or a conductive ITO film. In the embodiments shown in FIGS. 4 and 8, the resilient insulating layers can be made of poly ethylene terephthalate, FR4, polyimide, Mylar, poly carbonate or ethylene-vinyl acetate copolymer. The insulating blocks can be formed by ink printing in multiple layers, applying a double-sided adhesive tape, etching, non-conductive vacuum metallization, and so on.

What is claimed is:

1. A capacitive touchpad, comprising:
a protective layer;
a resilient conductive layer provided below the protective layer;
a sensor layer provided below the resilient conductive layer, the sensor layer having an upper surface provided with an insulating layer;
a plurality of first insulating blocks provided between the protective layer and the resilient conductive layer; and
a plurality of second insulating blocks provided between the resilient conductive layer and the sensor layer and offset in position with respect to the first insulating blocks;
wherein the sensor layer and the resilient conductive layer form a capacitor.

2. The capacitive touchpad of claim 1, wherein the resilient conductive layer comprises a conductive poly styrene film or a conductive indium tin oxide (ITO) film.

3. The capacitive touchpad of claim 1, wherein the first and the second insulating blocks are formed by ink printing in multiple layers, applying a double-sided adhesive tape, etching, or non-conductive vacuum metallization.

4. The capacitive touchpad of claim 1, wherein the sensor layer is a printed circuit board.

5. The capacitive touchpad of claim 1, wherein a first driving signal is applied to the sensor layer during detection of the capacitor.

6. The capacitive touchpad of claim 5, wherein a second driving signal in anti-phase with the first driving signal or a ground potential is applied to the resilient conductive layer during detection of the capacitor.

7. A capacitive touchpad, comprising:
a protective layer having a lower surface formed as a conductive electrode plate;
a resilient insulating layer provided below the protective layer;
a sensor layer provided below the resilient insulating layer ;
a plurality of first insulating blocks provided between the protective layer and the resilient insulating layer; and
a plurality of second insulating blocks provided between the resilient insulating layer and the sensor layer and offset in position with respect to the first insulating blocks;
wherein the sensor layer and the conductive electrode plate form a capacitor.

8. The capacitive touchpad of claim 7, wherein the resilient insulating layer comprises poly ethylene terephthalate, FR4, polyimide, Mylar, poly carbonate, or ethylene-vinyl acetate copolymer.

9. The capacitive touchpad of claim 7, wherein the first and the second insulating blocks are formed by ink printing in multiple layers, applying a double-sided adhesive tape, etching, or non-conductive vacuum metallization.

10. The capacitive touchpad of claim 7, wherein the sensor layer is a printed circuit board.

11. The capacitive touchpad of claim 7, wherein a first driving signal is applied to the sensor layer during detection of the capacitor.

12. The capacitive touchpad of claim 11, wherein a second driving signal in anti-phase with the first driving signal or a ground potential is applied to the conductive electrode plate during detection of the capacitor.

13. A capacitive touchpad, comprising:
a flexible sensor layer having an upper surface provided with a protective film and a lower surface provided with an insulating film;
a resilient conductive layer provided below the flexible sensor layer;
a bottom plate provided below the resilient conductive layer;
a plurality of first insulating blocks provided between the flexible sensor layer and the resilient conducive layer; and
a plurality of second insulating blocks provided between the resilient conductive layer and the bottom plate and offset in position with respect to the first insulating blocks;
wherein the flexible sensor layer and the resilient conductive layer form a capacitor.

14. The capacitive touchpad of claim 13, wherein the resilient conductive layer comprises a conductive poly styrene film or a conductive indium tin oxide (ITO) film.

15. The capacitive touchpad of claim 13, wherein the first and the second insulating blocks are formed by ink printing in multiple layers, applying a double-sided adhesive tape, etching, or non-conductive vacuum metallization.

16. The capacitive touchpad of claim 13, wherein a first driving signal is applied to the flexible sensor layer during detection of the capacitor.

17. The capacitive touchpad of claim 16, wherein a second driving signal in anti-phase with the first driving signal or a ground potential is applied to the resilient conductive layer during detection of the capacitor.

18. A capacitive touchpad, comprising:
a flexible sensor layer having an upper surface provided with a protective film;
a resilient insulating layer provided below the flexible sensor layer;
a conductive layer provided below the resilient insulating layer;
a plurality of first insulating blocks provided between the flexible sensor layer and the resilient insulating layer; and
a plurality of second insulating blocks provided between the resilient insulating layer and the conductive layer and offset in position with respect to the first insulating blocks;
wherein the flexible sensor layer and the conductive layer form a capacitor.

19. The capacitive touchpad of claim 18, wherein the resilient insulating layer comprises poly ethylene terephthalate, FR4, polyimide, Mylar, poly carbonate, or ethylene-vinyl acetate copolymer.

20. The capacitive touchpad of claim 18, wherein the first and the second insulating blocks are formed by ink printing in multiple layers, applying a double-sided adhesive tape, etching, or non-conductive vacuum metallization.

21. The capacitive touchpad of claim 18, wherein a first driving signal is applied to the flexible sensor layer during detection of the capacitor.

22. The capacitive touchpad of claim 21, wherein a second driving signal in anti-phase with the first driving signal or a ground potential is applied to the conductive layer during detection of the capacitor.
